(19) United States
(12) Patent Application Publication
(10) Pub. No.: US 2007/0126494 A1
(43) Pub. Date: Jun. 7, 2007

(54) Charge pump having shunt diode for improved operating efficiency

(75) Inventor: Feng Pan, Fremont, CA (US)

Correspondence Address: BEYER WEAVER LLP, P.O. BOX 70250, OAKLAND, CA, 94612-0250, US

(73) Assignee: SanDisk Corporation

(21) Appl. No.: 11/295,906

(22) Filed: Dec. 6, 2005

(51) Int. Cl. G05F 1/10

(52) U.S. Cl. 327/538

(57) ABSTRACT

The ramp up time of a change pump is decreased by providing shunt capacitors connecting nodes of the serially connected stages to the output terminal of the charge pump, thereby reducing the impedance of the charge pump and decreasing ramp up time.

### BACKGROUND OF THE INVENTION

This invention relates generally to electric circuits that generate a voltage larger than a supply voltage from which they operate by the switching of charge along serial capacitive cells, known as charge pumps.

A well known charge pump is the Dickson charge pump, which is shown in FIG. 1. As described by Louie Pylarinos of the University of Toronto in “Charge Pumps: An Overview”, the circuit has two pumping clocks which are anti-phased and have a voltage amplitude of Vφ or V̅φ̅. Serial diodes or diode connected NMOSFETS, D1-D4, operate as self-timed switches characterized by a forward biased voltage, Vt, which is the threshold voltage of each diode. Each diode has a stray capacitance, Cs, associated therewith. The charge pump operates by pumping charge along the diode chain as capacitors C1-C4 are successively charged and discharged during each clock cycle. For example, when Vφ goes high, diode D1 conducts and the voltage at its anode, V1, is boosted by voltage Vφ and transferred to node V2 less a voltage drop, Vt, associated with diode D1. Then when Vφ goes low, and V̅φ̅ goes high, the charge at node V2 is transferred to node V3 less a voltage drop, Vt, associated with diode V2. After N stages, it is seen that the output voltage is
Vₒᵤₜ=Vᵢₙ+N·(V_{φ}−V_{d})−V_{d} (1)

The charge pump is used, inter alia, in flash memories where a high voltage is needed for memory write and erase operations. Typically, a supply voltage of 1.5-3.0 volts must be upconverted to 30 volts. One limitation in the multi-stage charge pump is the time required to ramp up and the recovery time in achieving maximum voltage output.

The present invention is directed to improving the efficiency of a multi-stage charge pump.

### SUMMARY OF THE INVENTION

The impedance of a charge pump is approximately proportional to the number of stages in the pump chain, and the output ramp up voltage time is proportional to the impedance of the change pump. In accordance with the invention, charge pump impedance is reduced to thereby reduce output charge ramp up time.

In one embodiment of the invention, one or more shunt diodes are connected between nodes in the charge pump and the output, which reduces serial impedance between an input terminal and the output terminal at any given time. The shunt diodes disconnect each stage in turn as the output voltage builds up. The reduction in impedance can be effected with a shunt diode connecting a single node to the output, or with shunt diodes between a plurality of nodes, or all nodes, to the output. Available semiconductor chip wafer surface might not allow shunt diodes to all nodes.

The invention and object and features thereof will be more readily apparent from the following detailed description and appended claims when taken with the drawings.

### BRIEF DESCRIPTION OF THE DRAWINGS

FIG. 1 is a schematic of a conventional two phase charge pump having N stages.

FIG. 2 is an equivalent impedance schematic of the charge pump of FIG. 1.

FIG. 3 is a plot of output voltage versus time illustrating ramp up time in the output voltage for the charge pump of FIGS. 1 and 2.

FIG. 4 is a schematic of a charge pump having reduced impedance and increased charging efficiency in accordance with one embodiment of the invention.

FIGS. 5a, 5b are an equivalent impedance schematic of the charge pump of FIG. 4 and a plot of output voltage versus time.

### DETAILED DESCRIPTION OF THE PREFERRED EMBODIMENTS

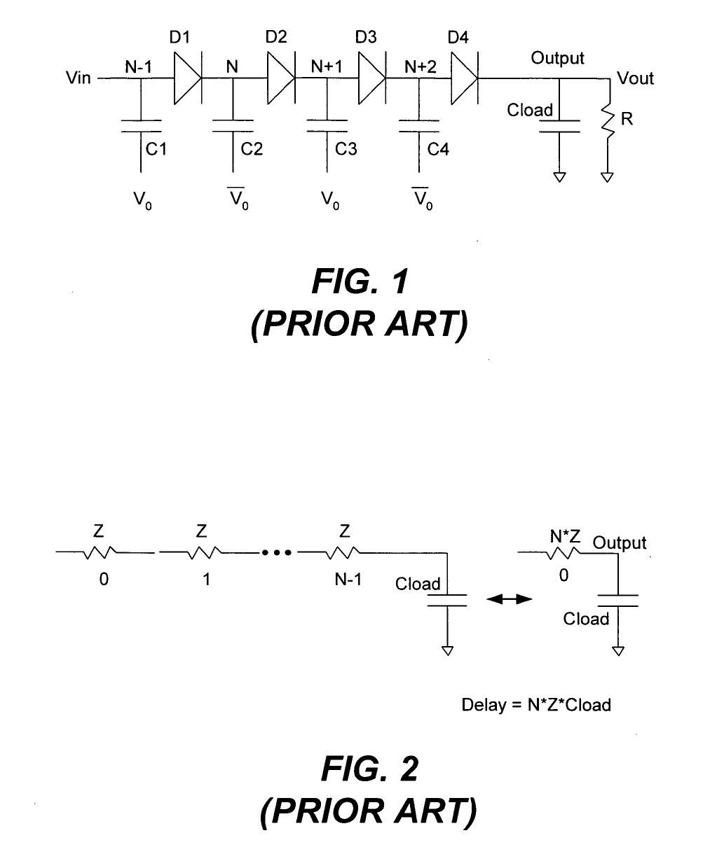

As noted above, the impedance of a charge pump is proportional to the number of stages in the charge pump chain. FIG. 2 is an equivalent electrical circuit of the conventional charge pump shown schematically in FIG. 1, where the impedance of each stage is given as Z. The impedance of an N stage charge pump will be approximately N·Z, as illustrated in FIG. 2.

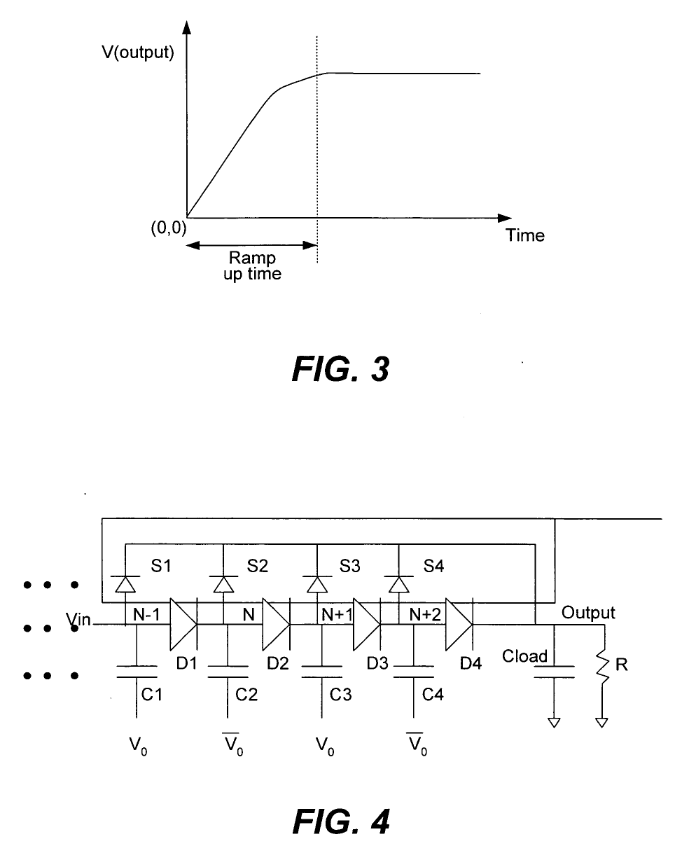

The output voltage ramp up time is proportional to the impedance of the charge pump. If the loading capacitance at the output terminal is Cload, the time constant is N Z Cload. The pump ramp up time is dependant on the initial voltage condition of the output terminal and the time constant N·Z·Cload, as illustrated in the plot of output voltage versus time in FIG. 3.

In accordance with the invention, one or more shunt diodes are connected between one or more nodes in the charge pump to the output terminal, as illustrated in FIG. 4. Here, the conventional charge pump illustrated in FIG. 1 is attended by adding shunt diodes S1-S4 between nodes of the charge pump and the output terminal. Each shunt diode is large enough to transfer accumulated charge at a node within one clock cycle. Thus, charge in the output load capacitor, Cload, begins accumulating through the shunt diodes as well as through the charge pump chain. As the charge on the load capacitor increases above the voltage on any one node, the shunt diode disconnects that node from the output terminal.

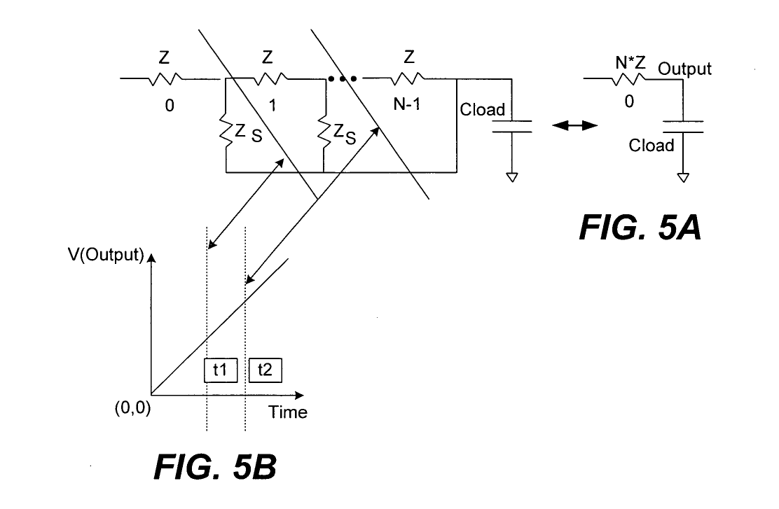

FIG. 5a is an equivalent circuit for the charge pump of FIG. 4 which shows the serial impedances, Z, of the charge pump being shunted by the impedances Z_{S} of the shunt diodes, thereby reducing the equivalent impedance of the charge pump. As noted above, the shunt diodes should be large enough to transfer charge on a node within one cycle but typically will be smaller than the serial diodes. While the output is ramping up, at any given point T1 or T2, as shown in FIG. 5b, the path from the first stage to the output always has the lowest impedance path. This allows the decrease in ramp up time as compared to the conventional charge pump.

While the invention has been described with reference to specific embodiments, the description is illustrative of the invention and is not to be construed as limiting the invention. Various applications may occur to those skilled in the art without departing from the spirit and scope of the invention as defined by the appended claims.

What is claimed is:

1. A charge pump having improved charging efficiency comprising:
a) an input terminal for receiving an input voltage,
b) an output terminal for receiving a pumped voltage higher than the input voltage,
c) a plurality of charge stages serially connected between the input terminal and the output terminal, each stage having a node, a capacitor connected to the node for increasing node voltage when driven by a clock voltage, and a serial diode connecting the node to a succeeding node, and
d) at least one shunt diode connecting a node to the output terminal.

2. The charge pump as defined by claim 1 wherein a plurality of shunt diodes connect a plurality of nodes to the output terminal.

3. The charge pump as defined by claim 2 wherein each serial diode and each shunt diode comprises a diode connected NMOSFET.

4. The charge pump as defined by claim 3 wherein each shunt diode is smaller than each serial diode.

5. The charge pump as defined by claim 4 and further including a load capacitance connected to the output terminal, ramp up time for the output terminal voltage being a function of impedance of the plurality of charge stages and shunt diode times the load capacitance.

6. The charge pump as defined by claim 5 wherein each node is connected through a shunt diode to the output terminal.

7. The charge pump as defined by claim 1 wherein each node in connected through a shunt diode to the output terminal.

8. The charge pump as defined by claim 7 wherein each shunt diode is smaller than each serial diode.

9. The charge pump as defined by claim 8 wherein each serial diode and each shunt diode comprises a diode connected NMOSFET.

10. The charge pump as defined by claim 1 wherein each shunt diode is smaller than each serial diode.

11. The charge pump as defined by claim 10 and further including a load capacitance connected to the output terminal, the ramp up time for the output terminal voltage being a function of impedance of the plurality of charge stages time the load capacitance.

12. The charge pump as defined by claim 1 and further including a load capacitance connected to the output terminal, the ramp up time for the output terminal voltage being a function of impedance of the plurality of charge stages time the load capacitance.

13. A method of improving efficiency in a multi-stage charge pump, where each stage includes a node, a capacitor coupled to the node for increasing node voltage when driven by a clock voltage, and a serial diode coupling the node to a succeeding node, the method comprising the step of connecting at least one shunt diode between a node in the charge pump to an output terminal to facilitate charge transfer from the node to the output terminal, the shunt diode disconnecting the node as output voltage exceeds voltage on the node.

14. The method as defined by claim 13 wherein a plurality of shunt diodes are connected between a plurality of nodes and the output terminal.

15. The method as defined by claim 14 wherein all nodes are connected by shunt diodes to the output terminal.
